(19) United States
(12) Patent Application Publication
(10) Pub. No.: US 2003/0056334 A1
(43) Pub. Date: Mar. 27, 2003

(54) Pull handle

(76) Inventor: Burl Finkelstein, Newnan, GA (US)

Correspondence Address: Robert B. Kennedy, Baker, Donelson, Bearman & Caldwell, Suite 900, Five Concourse Parkway, Atlanta, GA, 30328, US

(21) Appl. No.: 09/961,771

(22) Filed: Sep. 24, 2001

(51) Int. Cl. B62B 1/00

(52) U.S. Cl. 16/436

(57) ABSTRACT

A pull handle comprises a bar bearing an internally threaded insert adjacent each bar end, two spaced posts having a channel that is adapted to be mounted flushly to a door and a closed outside that has a collar in which an end of the bar is mounted. Two screws are provided to be threaded into the inserts through the post channels in mounting the posts and bar to the door.

### TECHNICAL FIELD

This invention relates generally to pull handles such as those used to pull open and to shut oven doors and the like, and more particularly to posts and bar type pull handles.

### BACKGROUND OF THE INVENTION

Most traditional post and bar handle designs utilize posts mounted to the door with the bar captured in a recess in the posts held only in place by the distance between the posts, as a towel bar for example. Handles not of the post and bar methods of construction cannot be produced in variable lengths to suit a particular application as their tooling or molds have to be made to finite sizes. Varying the bar length allows a post and bar handle to be made in any length.

Conventional posts and bar type handles are susceptible to breakage since the bar ends merely reside in a recess in the posts which makes it possible to pull the bar through the post recess by cracking the post. To prevent this the posts have had to be made of relatively thick and heavy metal. This of course is particularly undesirable for oven door applications due to the associated high thermal conductions. To substitute plastic is not a viable solution due to its strength insufficiency.

It thus is seen that a need has long existed for a pull handle of a posts and bar type design that possesses good structural integrity and sturdiness without having to be of massive metallic construction and which can be readily and securely mounted to an oven door or the like. Accordingly, it is to the provision of such that the present invention is primarily directed.

### SUMMARY OF THE INVENTION

In a preferred form of the invention, a pull handle comprises a bar bearing an internally threaded insert adjacent each bar end. Two spaced posts have a channel therein that extends from an open post inside that is adapted to be mounted flushly to a door and a closed outside. The outside has a collar in which an end of the bar is mounted and a pedestal atop which the bar is supported adjacent said collar. Screws are provided to be threaded into the inserts through the post channels in mounting the posts and bar as to a door.

### BRIEF DESCRIPTION OF THE DRAWING

FIG. 1 is a perspective view of a pull handle that embodies principles of the invention in its preferred form.

FIG. 2 is a side view of the pull handle of FIG. 1, shown partly in cross section.

FIGS. 3 and 5 are opposite end views of the pull handle of FIG. 1.

FIG. 4 is a front view of the pull handle of FIG. 1.

FIG. 6 is a bottom view of the pull handle of FIG. 1 with a mounting screw shown in one post only.

FIG. 7 is a cross sectional view of the pull handle taken along plane 7-7 showing a threaded insert.

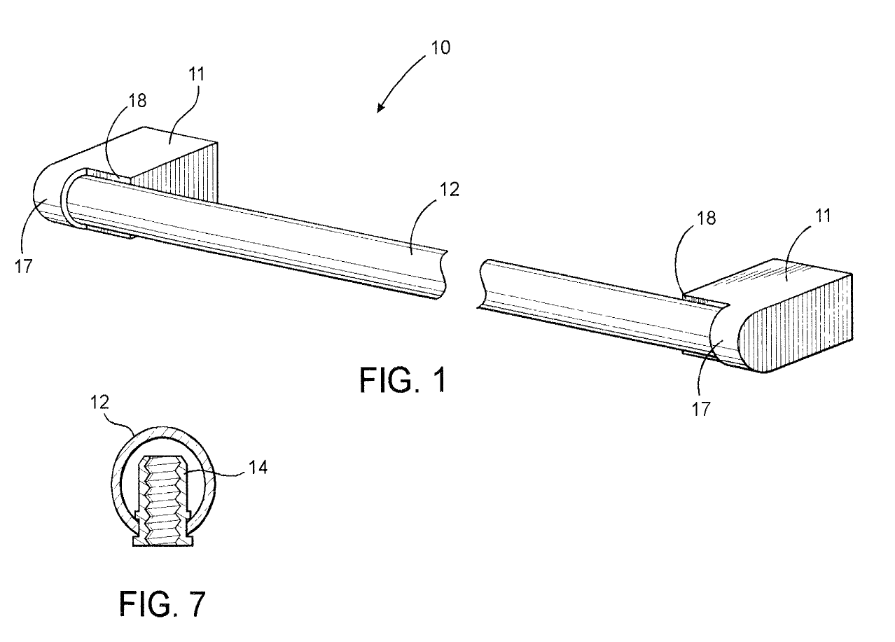

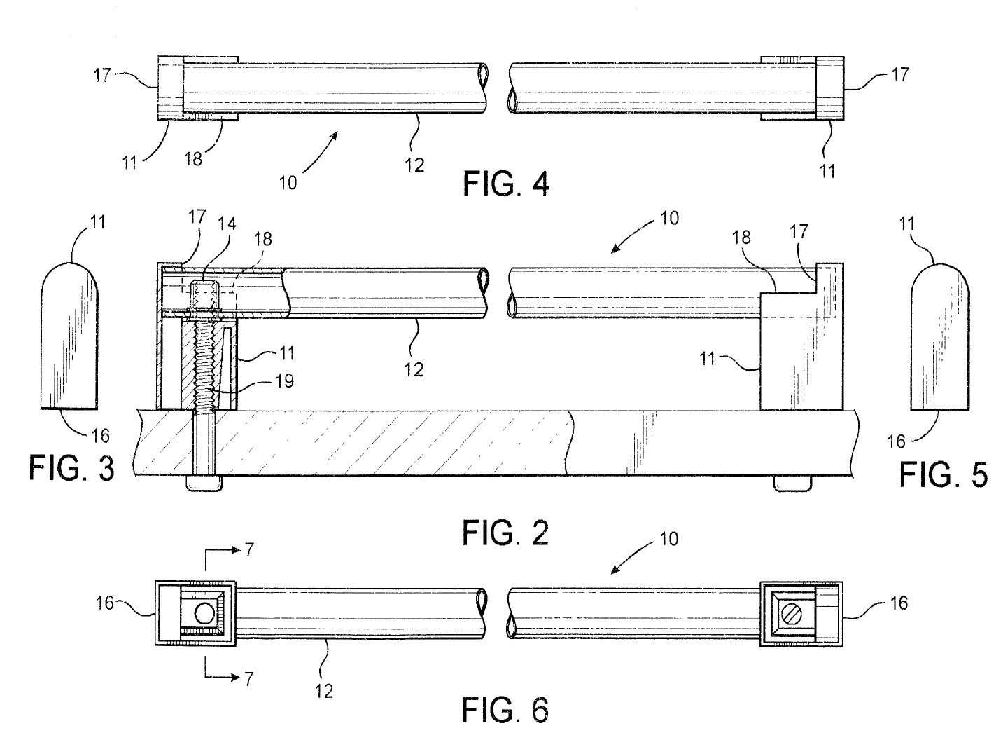

### DETAILED DESCRIPTION

With reference next in more detail to the drawings, there is shown a pull handle 10 that comprises two end posts 11 to which the ends of a handle bar 12 are mounted. The handle bar 12 is a length of cylindrical metallic tubing that is cut to the specific length desired for a specific application. Each end portion of the bar 12 has a hole in which an insert 14 is mounted that has internal threads. The insert may be a Rivnut fastener that has an internal flange formed in situ by barreling out with a threaded mandrel. Each post has an open inside 16 that is flat so as to be mountable flushly to a flat oven door. The outside of the post, opposite the inside, has a collar portion 17 with a cylindrical channel in which an end portion of the bar 12 is received. The outside of the post also has a pedestal portion 18 with a semi-cylindrical surface upon which a portion of the bar 12 adjacent its end portion is flushly supported and cradled.

The inside of the post is hollow such that the insert 14 is accessible from the open inside. Two screws 19 are provided that serve the dual roles of securing the post to the oven door and the bar to the post.

The handle bar 10 is mounted to an oven door by placing the inside of one post flushly to the door about a mounting hole in the door. One end of the bar 12 is seated within the post collar with its insert aligned normally to the door. A screw 19 is then passed through the oven door and through the inside of the post and threaded into the insert 14. The other bar end is then inserted into the collar of the other post and similarly mounted with the other screw. In this manner the bar is firmly secured to the two posts and the entire assembly securely mounted to the oven door.

With this new construction the pull handle can be easily mounted to an oven door or the like. The pull handle is sturdy and yet relatively light and thermally non-conductive.

Although the invention has been described and illustrated in its preferred form, it should be understood that many modifications, changes or additions may be made thereto without departure from the spirit and scope of the invention as set forth in the following claims.

1. A pull handle comprising a bar bearing an internally threaded insert adjacent each bar end, two spaced posts having a channel therein that extends from an open post inside that is adapted to be mounted flushly to a door and a closed outside that has a collar in which an end of said bar is mounted and a pedestal atop which said bar is supported adjacent said collar, and two screws sized to be threaded into said inserts through said post channels in mounting said posts and said bar to the door.

2. The pull handle of claim 1 wherein said pedestal has a concave surface on which said bar is supported.

3. A pull handle comprising a cylindrical bar that bears radially oriented internal threads in two end portions of said bar, two spaced hollow posts having an open post inside adapted to be mounted flushly to a door and an outside that has an outboard collar in which said bar end is mounted, and two screws sized to be threaded into said bar end threads in mounting said posts and bar to the door.

4. The pull handle of claim 3 wherein said outside of each of said posts has a pedestal with a generally semi-cylindrical channel in which a portion of said bar is cradled.
